(19) United States
(12) Patent Application Publication
(10) Pub. No.: US 2002/0081994 A1
(43) Pub. Date: Jun. 27, 2002

(54) Communication apparatus, and authentication method of the same

(75) Inventor: Kazunori Aoyagi, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA.

(21) Appl. No.: 10/025,771

(22) Filed: Dec. 26, 2001

(30) Foreign Application Priority Data
Dec. 27, 2000 (JP) 2000-398859

(51) Int. Cl. H04K 1/00

(52) U.S. Cl. 455/411; 455/410; 380/247

(57) ABSTRACT

A communication apparatus comprises an authentication code storage section, an authentication section configured to perform authentication of another communication apparatus using an authentication code stored in the authentication code storage section, and an authentication code updating section configured to calculate a new authentication code and update the authentication code stored in the authentication code storage section with the new authentication code when the authentication performed by the authentication section is successful.

### CROSS-REFERENCE TO RELATED APPLICATIONS

This application is based upon and claims the benefit of priority from the prior Japanese Patent Application No. 2000-398859, filed Dec. 27, 2000, the entire contents of which are incorporated herein by reference.

### BACKGROUND OF THE INVENTION

1. Field of the Invention

The present invention relates to a communication apparatus, and an authentication method for determining whether or not communication with a radio communication apparatus as the other party is permitted, and whether or not the other party is the third party permitted to communicate.

2. Description of the Related Art

Communication with an unspecified number of parties is possible in radio communication, and therefore a communication content is sometimes desired to be prevented from being acquired (intercepted) by the third party whose communication is not permitted during communication among a plurality of radio communication apparatuses in some case. In this case, a method is used which includes: exchanging authentication data (data based on a password, an identification number inherent to the apparatus, and the like) beforehand among the radio communication apparatuses, and permitting the communication only among the authenticated radio communication apparatuses; or exchanging key data for ciphering beforehand, and deciphering communication data based on the key data to perform communication.

In Bluetooth (trademark) ver.1 as one of short-distance radio communication systems, the authentication data is exchanged beforehand, and the communication is permitted only among the authenticated radio communication apparatuses as described in pages 171 to 185 of “Guidebook on New Technique Bluetooth of Wireless Communication” issued by Nikkan Kogyo Newspaper Co. (authored by Kazuhiro Miyazu, issued on Aug. 28, 2000).

Specifically, a radio communication apparatus A as a call originator transmits a connection request to a radio communication apparatus B as the other party, and the radio communication apparatus B receives the connection request. Additionally, the radio communication apparatuses A and B which permit the communication each other share a common authentication code.

The authentication codes are A and B into the radio communication apparatuses A and B, respectively. The authentication code is input using a user interface of a keyboard, and the like in some case, and the code stored in a memory inside the communication apparatus beforehand is utilized in other case.

The radio communication apparatus A generates a random number for authentication, and transmits the number to the radio communication apparatus B, and the radio communication apparatus B receives the random number for authentication. Each radio communication apparatus calculates authentication data using the identification number of the radio communication apparatus B, authentication code, and random number for authentication as parameters.

The radio communication apparatus B transmits the authentication data to the radio communication apparatus A as the call originator, and the radio communication apparatus A receives the authentication data.

The radio communication apparatus A collates the received authentication data calculated by the radio communication apparatus B with the authentication data calculated by the radio communication apparatus A itself. Here, radio communication apparatuses other than the radio communication apparatus B having the communication permitted do not know the authentication code, and cannot therefore calculate correct authentication data. Therefore, when the authentication data coincide with each other, the authentication is regarded as successful, and the radio communication apparatus B is notified of the success in authentication. When the authentication data do not coincide with each other, the authentication is regarded as failure, and the radio communication apparatus B is notified of the failure in authentication.

The radio communication apparatus B receives a notice (success or failure) of authentication result from the radio communication apparatus A, and determines that the authentication results in success or failure. When the authentication is successful, the data is transmitted/received between the radio communication apparatuses A and B. With the failure in authentication, connection is not completed, and data transmission/reception is not performed.

Among the parameters for use in authentication, the authentication code is directly input by the user interface, and is not intercepted by the third party. However, the identification number of the radio communication apparatus B as the other party can be acquired before start of the authentication. For example, the identification number of the radio communication apparatus located in the periphery and in conformity with Bluetooth can be acquired by an operation of Inquiry in Bluetooth, and there is a possibility of interception by the third party. Moreover, since the random number for authentication or the authentication data as a calculation result can be transmitted by radio, there is also a possibility of interception by the third party.

Therefore, with the interception of the random number, identification number of the radio communication apparatus, and authentication data as the calculation result using these parameters, there is a possibility that the authentication code is calculated backwards from the calculation result. The third party having obtained the authentication code or the identification number of the radio communication apparatus can prepare a new radio communication apparatus, pretend the radio communication apparatus of the identification number, and perform illicit radio communication.

As described above, in the authentication of the conventional radio communication apparatus, it is possible to acquire the parameter for calculating the authentication data by interception, and there is a fear that the illicit communication is performed by pretense. Additionally, this problem is not limited to the radio communication apparatus, and also possibly occurs with a wired communication apparatus.

### BRIEF SUMMARY OF THE INVENTION

An object of the present invention is to provide a communication apparatus capable of preventing an illicit communication by pretense even when the third party intercepts communication and analyzes data for authentication, and an authentication method of the apparatus.

According to the embodiment of the present invention, data calculated from a predetermined parameter and used in authentication is updated for each authentication. Thereby, even when the third party intercepts the communication and analyzes the data used in the authentication, the illicit communication can be prevented. Because the authentication data is updated during the next authentication, the analyzed authentication data becomes invalid.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing a constitution of an embodiment of a radio communication apparatus according to the present invention;

FIG. 2 is a diagram showing an authentication code stored in an authentication code storage section of the embodiment; and

FIGS. 3A and 3B are a flowchart showing an authentication method according to the present invention.

### DETAILED DESCRIPTION OF THE INVENTION

An embodiment of a communication apparatus according to the present invention will now be described with reference to the accompanying drawings.

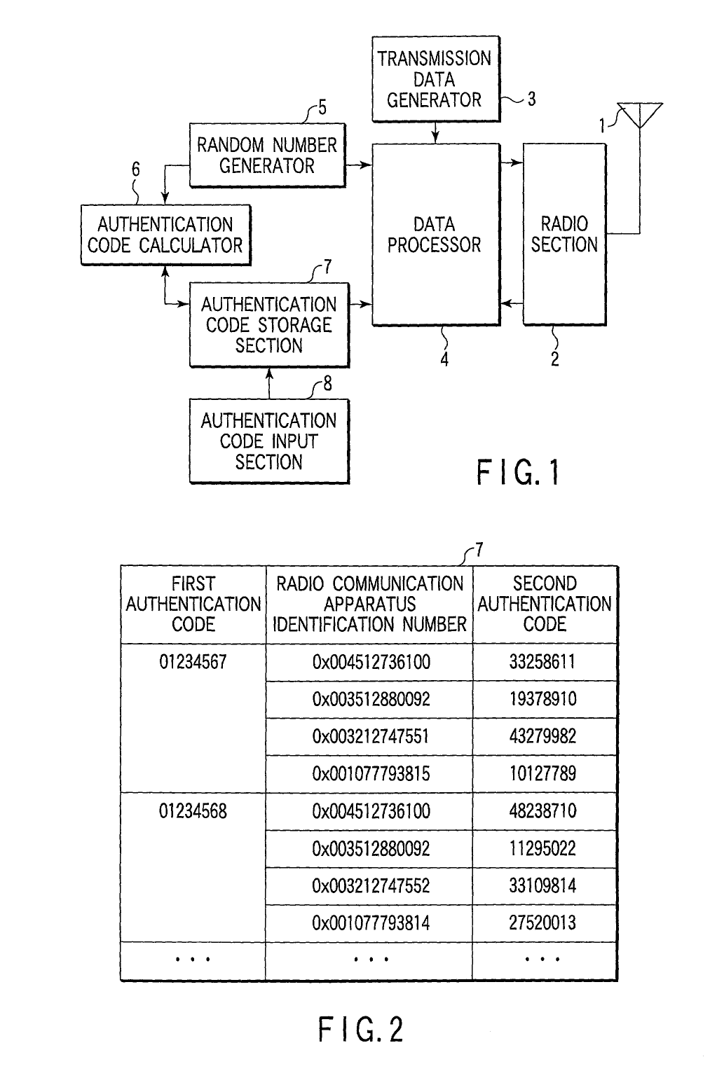

FIG. 1 is a block diagram showing the embodiment of a radio communication apparatus according to the present invention.

A radio section 2, and transmission data generator 3 are connected to a data processor 4 including a CPU. An antenna 1 is connected to the radio section 2, and performs demodulation of received data, modulation of transmission data, and the like. The transmission data generator 3 generates actual communication data, and transmits the data to a radio communication apparatus as the other party via the data processor 4, radio section 2, and antenna 1. An authentication code input section 8 having a user interface such as a keyboard is used to input an authentication code. The authentication code input from the authentication code input section 8 is stored in an authentication code storage section 7.

In the present embodiment, there are two types of authentication codes, that is, first and second authentication codes, and the authentication code input from the authentication code input section 8 is stored as the first authentication code in the authentication code storage section 7. The first authentication code is not used in authentication, and the second authentication code is used in the authentication. The authentication code for use in the authentication is referred to as the authentication code for calculation. The second authentication code is determined for each radio communication apparatus as the other party, an initial value is the first authentication code, but the subsequent value is updated every authentication. Therefore, the authentication code for calculation is updated every authentication. For the updating calculation, an authentication code calculator 6 is connected to the authentication code storage section 7, and the second authentication code is updated based on a random number generated from a random number generator 5. The second authentication code is also stored in the authentication code storage section 7.

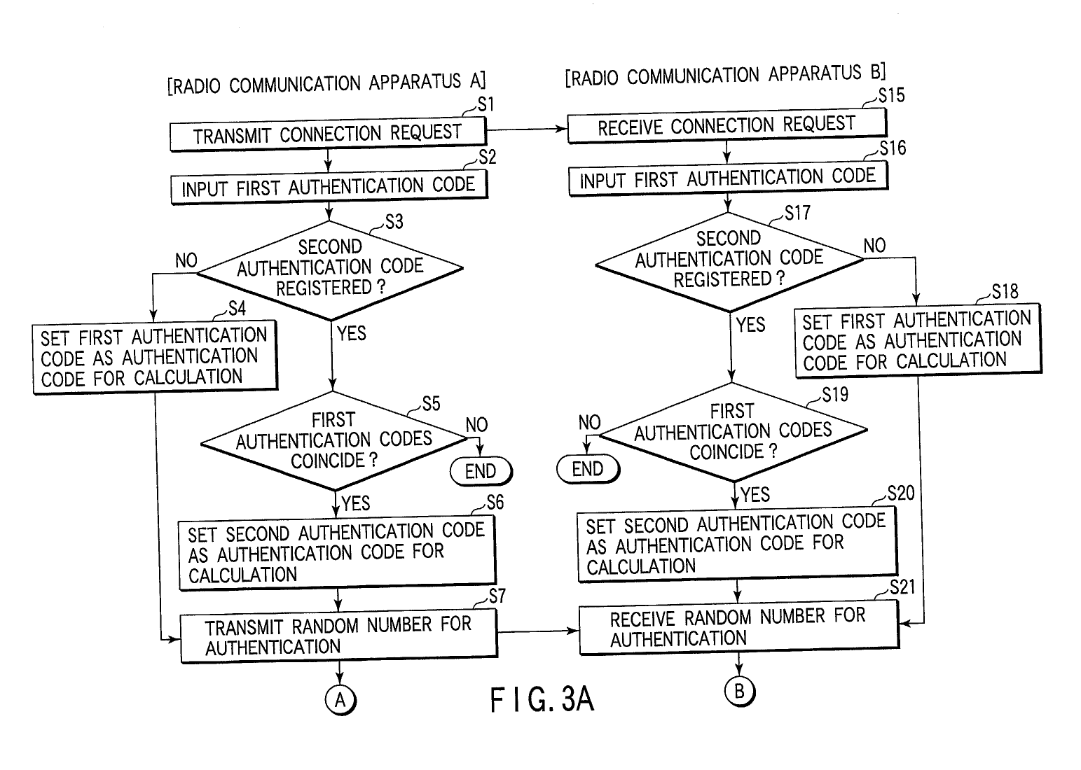

FIG. 2 shows a content of the authentication code storage section 7. For the first authentication code, different codes are set for respective apparatus groups for communication, and therefore a case in which a plurality of codes are stored is shown. However, when the first authentication code is used in common for any group, a single code may be stored.

The data processor 4 allows the random number generator 5 to generate the random number for authentication, and processes transmission/reception data, when the first authentication code input from the authentication code input section 8 coincides with the first authentication code stored in the authentication code storage section 7. That is, the data processor 4 transmits the random number for authentication to the radio section 2. The radio section 2 performs the modulation of the transmission data, demodulation of received data, and the like. Subsequently, the random number for authentication is transmitted to the radio communication apparatus as the other party via the antenna 1.

On the other hand, the radio communication apparatus as the other party having received the random number for authentication via the antenna 1 demodulates the received data by the radio section 2, and transmits demodulated data to the data processor 4. The data processor 4 uses the received random number for authentication, the second authentication code stored in the authentication code storage section 7, and an identification number of the radio communication apparatus itself as parameters to calculate the authentication data. Subsequently, the authentication data is sent to the radio section 2, and transmitted to the radio communication apparatus as the call originator via the antenna 1.

Moreover, also in the radio communication apparatus as the call originator, the data processor 4 uses the random number for authentication generated by itself, the second authentication code, and the identification number of the radio communication apparatus as the other party as the parameters to calculate the authentication data. The authentication data calculated by itself is compared with the authentication data received from the other party via the antenna 1 and radio section 2. When both data coincide with each other, the authentication is regarded as successful, and a notice of success in authentication is transmitted to the radio communication apparatus as the other party from the data processor 4 via the radio section 2 and antenna 1. Thereafter, the transmission data generator 3 generates the data for actual communication, and data transmission/reception is performed with the radio communication apparatus as the other party via the data processor 4, radio section 2, and antenna 1.

Furthermore, with the success in the authentication, the authentication code calculator 6 uses the random number generated by the random number generator 5 at a start of authentication, and the second authentication code stored in the authentication code storage section 7 as the parameters to calculate a new second authentication code, and updates the second authentication code of the authentication code storage section 7. During the next authentication, the same first authentication code is input from the authentication code input section 8, but the updated second authentication code is used in calculating the authentication data instead of the first authentication code.

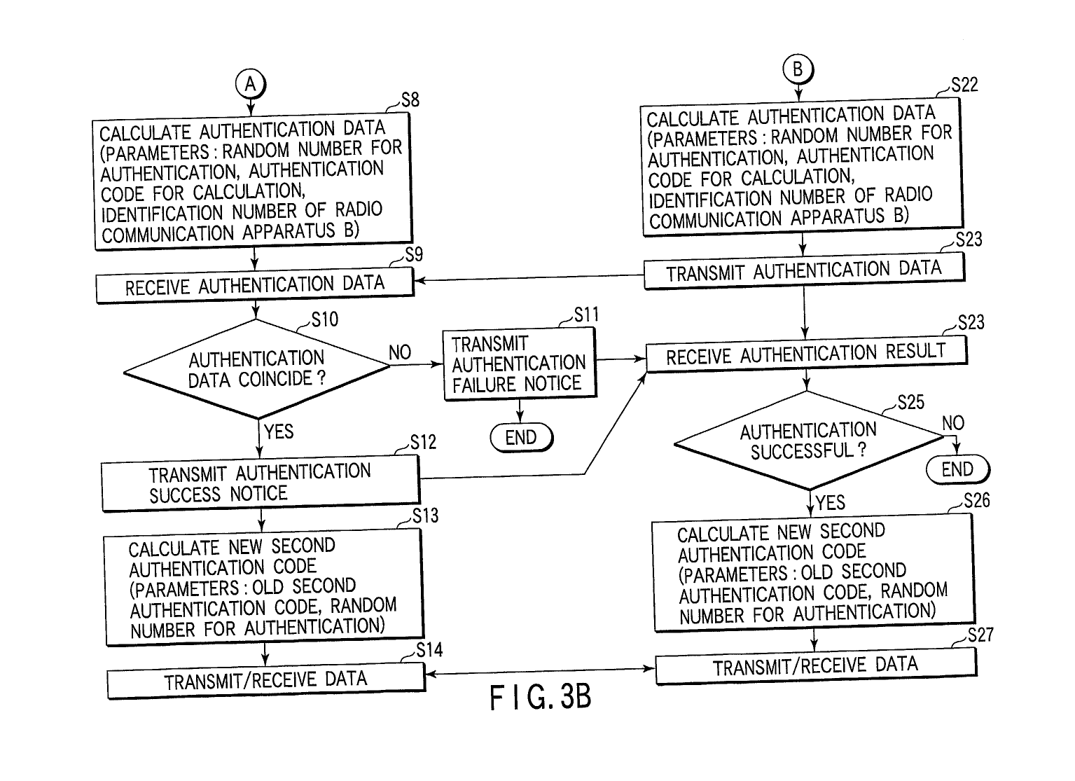

A detail of an authentication procedure will next be described with reference to a flowchart of FIGS. 3A and 3B. Here, a case in which the radio communication apparatus A performs the authentication of the radio communication apparatus B prior to the communication with the radio communication apparatus B will be described.

The radio communication apparatus A designates the identification number of the radio communication apparatus B and transmits a connection request in step S1. The radio communication apparatus B receives the connection request from the radio communication apparatus A in step S15.

In steps S2 and S16, the first authentication code is input to the radio communication apparatuses A and B, respectively. The authentication code may be input using the user interface such as the keyboard, and additionally the code stored beforehand in a memory inside the communication apparatus may also be utilized.

In steps S3 and S17, it is determined in the respective radio communication apparatuses A and B whether or not the second authentication code is already registered. When the second authentication code is not registered in the authentication code storage section 7, the flow advances to steps S4 and S18, and the first authentication code is set as the authentication code for calculation for use in calculating the authentication data.

When the second authentication code is already registered, and it is determined in steps S5 and S19 in the respective radio communication apparatuses A and B whether an input first authentication code coincides with the first authentication code stored in the authentication code storage section 7. When both codes do not coincide with each other, the authentication is regarded as failure, and the processing is ended.

When the input first authentication code coincides with the first authentication code stored in the authentication code storage section 7 in steps S5 and S19, the flow advances to steps S6 and S20, and the second authentication code is set as the authentication code for calculation for use in calculation of the authentication data.

Subsequently, in the radio communication apparatus A as the call originator, in step S7, the random number for authentication is generated from the random number generator 5, and transmitted to the radio communication apparatus B as the other party. In the radio communication apparatus B, the random number for authentication is received in step S21.

Subsequently, in steps S8 and S22, in the respective radio communication apparatuses A and B, the random number for authentication, authentication code for calculation, and identification number of the radio communication apparatus B are used as the parameters to calculate the authentication data. The authentication code for calculation is the first authentication code set in steps S4 and S18 during a first authentication (the second authentication code is not registered), and the second authentication code set in steps S6 and S20 during second and subsequent authentication (the second authentication code is already registered).

The authentication data generated as a result of calculation by the radio communication apparatus B is transmitted to the radio communication apparatus A in step S23, and the radio communication apparatus A receives the authentication data from the radio communication apparatus B in step S9.

In step S10, the radio communication apparatus A collates the authentication data received in step S9 with the authentication data generated as the result of calculation in step S8. When the data do not coincide with each other, an authentication failure notice is transmitted to the radio communication apparatus B as the other party in step S11, thereby ending the flow. When the data coincide with each other, an authentication success notice is transmitted to the radio communication apparatus B as the other party in step S12, and the flow advances to step S13.

The radio communication apparatus B receives an authentication result transmitted from the radio communication apparatus A in step S24. It is determined in step S25 whether or not the authentication is successful. With the unsuccessful authentication, the flow ends. With the successful authentication, the flow advances to step S26.

In steps S13 and S26, the radio communication apparatuses A and B perform the same calculation processing from the random number for authentication transferred in steps S7 and S21, and the second authentication code stored in the authentication code storage section 7, and generate a new second authentication code. The generated second authentication code is stored in the authentication code storage section 7, and the second authentication code is updated. A method of calculating the second authentication code includes, for example, obtaining an exclusive OR of the random number for authentication and the second authentication code.

Thereafter, in steps S14 and S27, communication data is transmitted/received between the radio communication apparatuses A and B.

When the authentication is again performed, steps S2 to S13, and steps S16 to S26 are repeated.

Here, it is assumed that the authentication data and the parameter for calculating the authentication data are intercepted by the third party while they are transmitted via a wireless channel. Similarly as the conventional method, there is a fear that the authentication code for calculation as one of the calculation parameters of the authentication data is calculated backwards from the random number for authentication, the authentication data, and the identification number of the radio communication apparatus B. However, according to the embodiment, the authentication code for calculation is updated after each authentication (the first authentication code is used for the first time, and the second authentication code is used for second and subsequent times of authentication). Therefore, it is necessary to intercept the communication and analyze the authentication code for calculation every authentication, and it is difficult to analyze the code.

Additionally, even if the authentication code for calculation is analyzed, the authentication code for calculation is separate from the authentication code input in step S16. Therefore, during the next authentication, even when an analysis result is input in step S16, the input authentication code does not coincide with the stored authentication code in step S19, and the authentication fails. Thereby, the third party can be prevented from intercepting the communication, illicitly acquiring the authentication code, and pretending to perform the communication.

As described above, according to the present embodiment, the authentication code input during the authentication is set to be separate from the authentication code for actual use in the authentication. Furthermore, the authentication code for actual use in the authentication is changed every authentication. Even when the third party intercepts the communication and analyzes the authentication code used in the authentication, the authentication code is updated during the next authentication, the analyzed authentication code becomes invalid, and illicit communication can be prevented.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

In the above description, the random number for authentication transmitted to the radio communication apparatus B from the radio communication apparatus A and the second authentication code are used as the parameters to perform the predetermined calculation and the second authentication code is updated. However, the method of updating the second authentication code is not limited to the aforementioned method as long as the radio communication apparatuses A and B generate the new authentication code by the same calculation method.

The present invention can be applied not only to the radio communication apparatus but also to a wired communication apparatus.

Moreover, the present invention can also be implemented as a computer readable recording medium in which a program for allowing a computer to execute predetermined means, allowing the computer to function as predetermined means, or allowing the computer to realize a predetermined function is recorded.

As described above, according to the present invention, the data calculated from the predetermined parameter and used in the authentication is changed every authentication. Even when the third party intercepts the communication and analyzes the data used in the authentication, the authentication data is updated during the next authentication, the analyzed authentication data becomes invalid, and the illicit communication can be prevented.

What is claimed is:

1. A communication apparatus comprising:
an authentication code storage section;
an authentication section configured to perform authentication of another communication apparatus using an authentication code stored in said authentication code storage section; and
an authentication code updating section configured to calculate a new authentication code and update the authentication code stored in said authentication code storage section with the new authentication code when the authentication performed by said authentication section is successful.

2. The apparatus according to claim 1, further comprising:
a comparator configured to compare an input authentication code with a predetermined authentication code;
an ending section configured to end the authentication performed by said authentication section when both codes do not coincide with each other; and
a starting section configured to operate said authentication section and said authentication code updating section when the both codes coincide with each other.

3. The apparatus according to claim 2, wherein said authentication section performs the authentication of the other communication apparatus using said input authentication code when the authentication code is not stored in said authentication code storage section.

4. The apparatus according to claim 2, wherein said authentication section performs the authentication of the other communication apparatus using identification data of the other communication apparatus and the authentication code which is the input authentication code when said authentication code storage section does not store authentication data of the other communication apparatus.

5. The apparatus according to claim 1, wherein said authentication section calculates authentication data based on identification data of the other communication apparatus and the authentication code and collates the calculated authentication data with authentication data of the other communication apparatus.

6. The apparatus according to claim 5, wherein said authentication section calculates the authentication data based on the identification data of the other communication apparatus, the authentication code and a random number.

7. The apparatus according to claim 1, wherein said authentication code updating section subjects the authentication code stored in said authentication code storage section and used in the authentication to a predetermined calculation, and generates a new authentication code.

8. The apparatus according to claim 7, wherein said authentication code updating section subjects the authentication code stored in said authentication code storage section and used in the authentication and a random number to the predetermined calculation, and generates the new authentication code.

9. An authentication method between two communication apparatuses, comprising:
transmitting predetermined data to the apparatus to be authenticated from the apparatus demanding authentication;
calculating authentication data in the two communication apparatuses based on said predetermined data, an authentication code for calculation, and identification data of the apparatus to be authenticated;
comparing the obtained authentication data of both the apparatuses with each other in the apparatus demanding authentication; and
updating the authentication code for calculation in the two communication apparatuses based on the predetermined data and the authentication code for calculation when the authentication data of both the apparatuses coincide with each other.

10. The method according to claim 9, wherein an authentication code is input into each apparatus to be compared a predetermined authentication code and the authentication is ended when the input authentication code does not coincide with the predetermined authentication code.

11. The method according to claim 9, wherein an initial value of said authentication code for calculation is an input authentication code.

12. The method according to claim 9, wherein said predetermined data is a random number.

13. A communication apparatus having a function for authenticating another communication apparatus, comprising:
a comparator configured to compare an input first code or a prestored first code with a predetermined code;
an ending section configured to end an authentication when the first code and the predetermined code do not coincide with each other;
a transmitter configured to transmit a random number to the other communication apparatus when both of the first codes coincide with each other;
a collation section configured to calculate authentication data based on the random number, an authentication code, and identification data of the other communication apparatus, and collate the calculated authentication data with authentication data transmitted from the other communication apparatus; and
an updating section configured to update the authentication code based on the random number and the authentication code when both of the authentication data coincide with each other.

14. The apparatus according to claim 13, wherein said updated authentication code is stored in a storage section, and said collation section uses the input first code as the authentication code when the authentication code is not stored in the storage section.

15. A communication apparatus comprising:
a comparator configured to compare an input first code or a prestored first code with a predetermined code when authentication is requested by another communication apparatus;
an ending section configured to end an authentication when the first code and the predetermined code do not coincide with each other;
a receiver configured to receive a random number from the other communication apparatus;
a transmitter configured to calculate authentication data based on the random number, an authentication code, and identification data of own apparatus and transmit the calculated authentication data to the other communication apparatus; and
an updating section configured to receive a result of authentication from the other communication apparatus and update the authentication code based on the random number and the authentication code when the authentication is successful.

16. The apparatus according to claim 15, wherein said updated authentication code is stored in a storage section, and said transmission section uses the first code as the authentication code when the authentication code is not stored in the storage section.

17. An article of manufacture comprising a computer usable medium having a computer readable program code embodied therein, the computer readable program comprising:
a first computer readable program code for causing a computer to allow two communication apparatuses authenticate each other using authentication code; and
a second computer readable program code for causing a computer to calculate a new authentication code, and update the authentication code, when the authentication is successful.

18. The article of manufacture according to claim 17, wherein the first program code causes a computer to calculate authentication data based on an authentication code shared by the two communication apparatuses, identification data of one of the two communication apparatuses, and a predetermined code generated by said one of the two communication apparatuses and transmitted to the other of the two communication apparatuses and to collate the authentication data of the two communication apparatuses.

19. A communication apparatus comprising:
an input section configured to input a first authentication code;
an output section configured to output a second authentication code corresponding to the first authentication code input by the input section;
an authentication section configured to perform authentication for setting a communication link with an external apparatus using the second authentication code output from the output section; and
an updating section configured to update the second authentication code to a code different from the second authentication code output from said output section when the authentication by the authentication section is successful.

20. An authentication method of a communication apparatus, the method comprising:
inputting a first authentication code;
outputting a second authentication code corresponding to the input first authentication code;
performing authentication for setting a communication link with an external apparatus using the output second authentication code; and
updating the second authentication code to a code different from the output second authentication code when the authentication is successful.
